(19) United States
(12) Patent Application Publication
(10) Pub. No.: US 2013/0307456 A1
(43) Pub. Date: Nov. 21, 2013

(54) ELECTRIC TURNING DEVICE

(71) Applicant: SUMITOMO HEAVY INDUSTRIES, LTD., Tokyo (JP)

(72) Inventor: Tetsuji ONO, Chiba (JP)

(73) Assignee: SUMITOMO HEAVY INDUSTRIES, LTD., Tokyo (JP)

(21) Appl. No.: 13/873,334

(22) Filed: Apr. 30, 2013

(30) Foreign Application Priority Data
May 18, 2012 (JP) 2012-115063

(51) Int. Cl. H02P 7/28

(52) U.S. Cl. CPC H02P 7/28
USPC 318/453

(57) ABSTRACT

An electric turning device includes an electric motor configured to drive and turn an upper turning body that is rotatably arranged on a base part, an inverter that supplies electric power to the electric motor, a control part that supplies a drive command for controlling drive operations of the electric motor to the electric motor according to a lever input amount, and an abnormality detecting part that detects an abnormality. When the abnormality detecting part detects the abnormality, the control part arranges the drive command to include a vibration component and supplies the drive command including the vibration component to the electric motor.

### CROSS-REFERENCE TO RELATED APPLICATIONS

The present application is based on and claims the benefit of priority to Japanese Patent Application No. 2012-115063, filed on May 18, 2012, the entire contents of which are incorporated herein by reference.

### BACKGROUND OF THE INVENTION

1. Field of the Invention The present invention relates to an electric turning device that drives a turning body of a construction machine or an operating machine.

2. Description of the Related Art

Operating machines and construction machines such as excavators generally include a turning device for driving a turning body to which a work element is mounted so that the work element may be turned and moved to a work station. Such a turning device may use a hydraulic motor or an electric motor as a drive source. The tuning device that uses an electric motor as the drive source is generally referred to as “electric turning device.”

Turning operations of the tuning device are typically controlled by an operator that operates an operation device. For example, in an excavator including a turning device that drives a turning body, the driver (operator) of the excavator manually operates an operation lever arranged at the driver seat to move the turning body to a desired position. When turning the turning body, the driver would be constantly holding and operating the operation lever.

Techniques have previously been proposed for notifying the operator of a failure by causing the operation lever to vibrate when failure occurs during operation of the excavator (See, e.g., Japanese Unexamined Patent Publication No. 2003-184131). Such failure notification is enabled by embedding a vibration generating device inside the operation lever and prompting the vibration generating device to vibrate when failure occurs during operation of the excavator so that the operator may feel the vibration and become aware of the failure.

However, in the case where a vibration generating device is embedded in the operation lever, normal operations of the operation lever by the operator may be impaired because the operation lever itself vibrates when failure occurs. For example, when the operation lever vibrates while the operator is operating the operation lever, the operator's attention may be directed to the operation lever and the operator may inadvertently let go of the operation lever to cause the operation of the turning body to halt or the operator may operate the operation lever in an unintended manner.

### SUMMARY OF THE INVENTION

According to one embodiment of the present invention, an electric turning device includes an electric motor configured to drive and turn an upper turning body that is rotatably arranged on a base part, an inverter that supplies electric power to the electric motor, a control part that supplies a drive command for controlling drive operations of the electric motor to the electric motor according to a lever input amount, and an abnormality detecting part that detects an abnormality. When the abnormality detecting part detects the abnormality, the control part arranges the drive command to include a vibration component and supplies the drive command including the vibration component to the electric motor.

### BRIEF DESCRIPTION OF THE DRAWINGS

FIG. 1 is a side view of a hybrid excavator in which an electric turning device of the present invention may be implemented;

FIG. 2 is a block diagram illustrating a configuration of an electric turning device according to an embodiment of the present invention;

FIG. 3 is a circuit diagram illustrating a configuration of an electrical energy storage system;

FIG. 4 is a block diagram illustrating a functional configuration for generating a drive command by adding a vibration component to a speed command; and

FIG. 5 is a block diagram illustrating a functional configuration for generating a drive command by adding a vibration component to a torque current command.

### DETAILED DESCRIPTION OF THE PREFERRED EMBODIMENTS

According to an aspect of the present invention, an electric turning device is provided that is capable of notifying an operator of an abnormality or a failure by causing vibration of an upper turning body rather than the operation lever. By adding a vibration component to the turning operation of the upper turning body that causes the operator to sense an awkwardness in the movement of the upper turning body, the operator may be notified of an abnormality or a failure in the operations of the upper turning or the surrounding environment.

In the following, embodiments of the present invention are described with reference to the accompanying drawings.

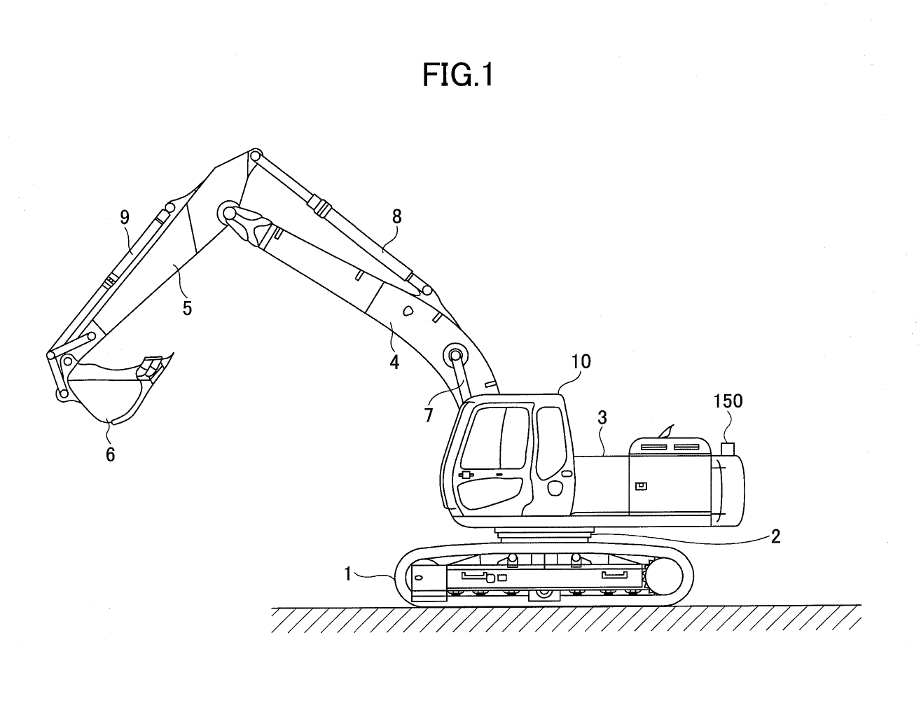

FIG. 1 is a side view of a hybrid excavator as an exemplary excavator in which an electric turning device according to an embodiment of the present invention may be implemented. It is noted that the electric turning device according to the present invention may be installed in not only an excavator but also other types of operating machines and construction machines that have a turning body to which a work element is mounted.

A lower running body 1 of the hybrid excavator illustrated in FIG. 1 carries an upper turning body 3 through a turning mechanism 2. A boom 4 is attached to the upper turning body 3. An arm 5 is attached at the end of the boom 4. A bucket 6 is attached at the end of the arm 5. The boom 4, the arm 5, and the bucket 6 are hydraulically driven by a boom cylinder 7, an arm cylinder 8, and a bucket cylinder 9, respectively. A cabin 10 is arranged in the upper turning body 3, and the source of power, such as an engine, is installed in the upper turning body 3. A driver of the excavator places himself inside the cabin 10 and operates an operation lever to operate the excavator.

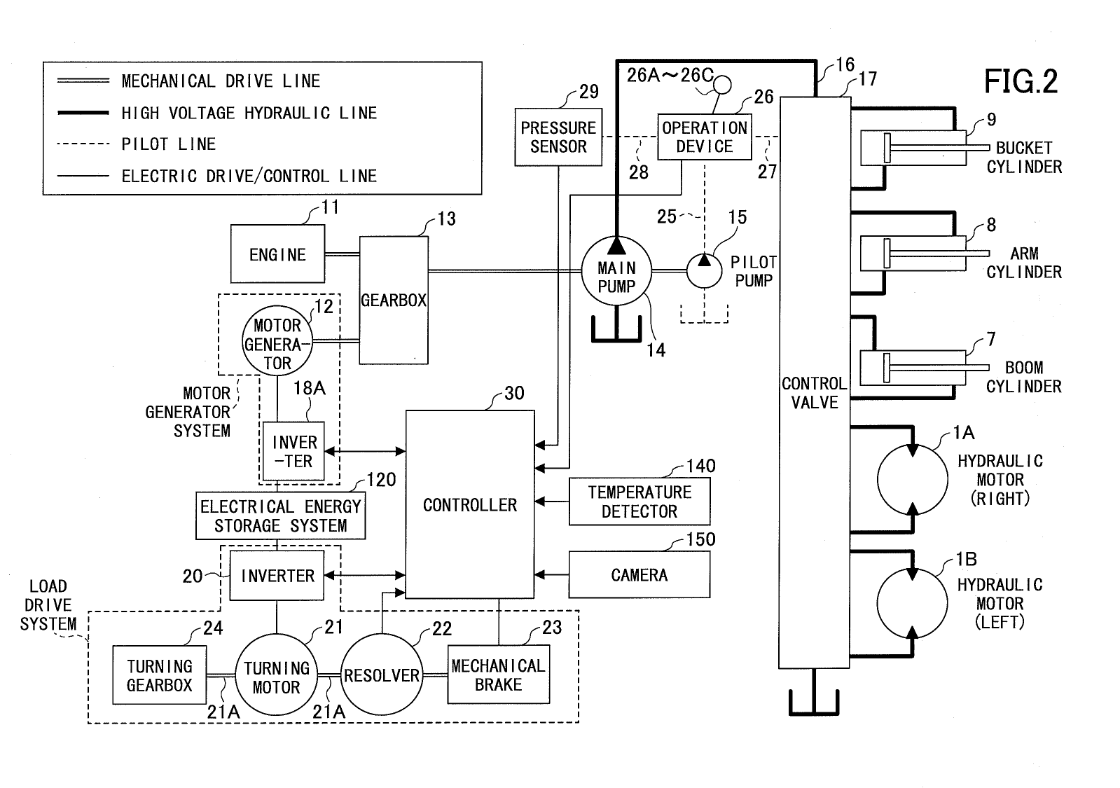

FIG. 2 is a block diagram showing a configuration of a drive system of the hybrid excavator illustrated in FIG. 1. In FIG. 2, the double line denotes a mechanical drive line, the thick solid line denotes a high voltage hydraulic line, the dotted line denotes a pilot line, and the thin solid line denotes an electric drive/control line.

An engine 11 as a mechanical drive part and a motor generator 12 as an assist drive part are connected to two input axes of a gearbox 13. A main pump 14 as a hydraulic pump and a pilot pump 15 are connected to the output axis of the gearbox 13. A control valve 17 is connected to the main pump 14 via a high voltage hydraulic line 16.

The control valve 17 is a control unit which controls a hydraulic system of the hybrid excavator. A hydraulic motor 1A (for the right side) and a hydraulic motor 1B (for the left side) are provided for driving the lower running body 1. The hydraulic motors 1A and 1B, the boom cylinder 7, the arm cylinder 8, and the bucket cylinder 9 are connected to the control valve 17 via the high voltage hydraulic line.

An electrical energy storage system 120 including an electrical energy storage device is connected to the motor generator 12 via an inverter 18A. An operation device 26 is connected to the pilot pump 15 via the pilot line 25. The operation device 26 includes a lever 26A, a lever 26B, and a pedal 26C. The lever 26A, the lever 26B, and the pedal 26C are connected to the control valve 17 and a pressure sensor 29 via a hydraulic line 27 and a hydraulic line 28. The pressure sensor 29 is connected to a controller 30 that controls drive operations of the electric system.

An electric turning device, including a turning motor 21 for driving the turning mechanism 2, is installed in the hybrid excavator illustrated in FIG. 1. The turning motor 21, as an electric motor according to an embodiment of the present invention, is connected to the electrical energy storage system 120 via an inverter 20. A resolver 22, a mechanical brake 23, and a turning gearbox 24 are connected to a rotational axis 21A of the turning motor 21. The turning motor 21, the inverter 20, the resolver 22, the mechanical brake 23, and the turning gearbox 24 constitute a load drive system. Further, the electric turning device includes the turning mechanism 2, the turning motor 21 for driving the tuning mechanism 2, the inverter 20 that supplies electric power to the turning motor 21, and the controller 30 that controls the drive operations of the turning motor 21.

The controller 30 acts as a main control unit that controls drive operations of the hybrid excavator. The controller 30 comprises an arithmetic processing unit including a CPU (central processing unit) and an internal memory. Control operations of the controller 30 may be implemented by the CPU executing drive control programs stored in the internal memory.

The controller 30 converts a signal received from the pressure sensor 29 into a speed command, and controls drive operations of the turning motor 21 using the speed command. The signal received from the pressure sensor 29 is equivalent to a signal indicating an operation amount (input amount) of the operation device 26 that is operated to turn the turning mechanism 2.

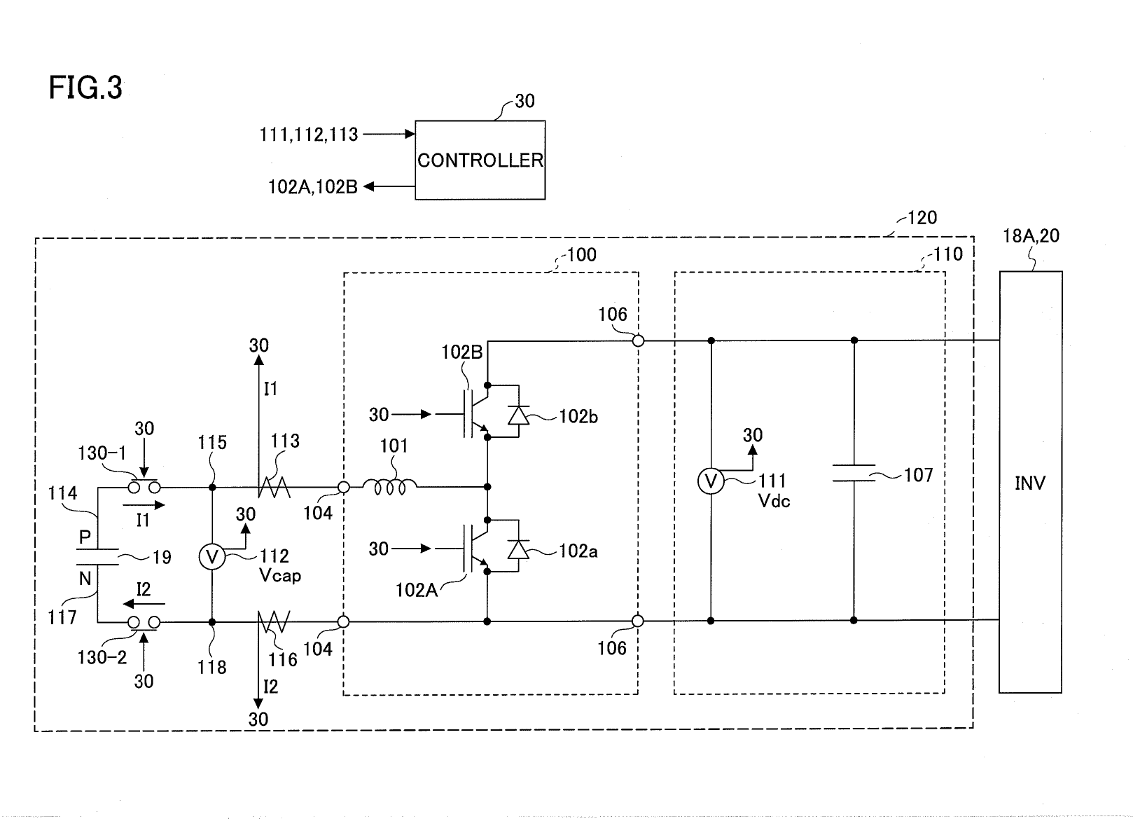

The controller 30 controls operations of the motor generator 12 (switching between a motor-assisted operation and a power generating operation), and controls operations of an up-down voltage converter 100 (see FIG. 3) corresponding to a voltage raising/lowering control unit for controlling charging/discharging of the capacitor 19 (see FIG. 3). The controller 30 controls switching between the voltage raising operation and the voltage lowering operation of the up-down voltage converter 100 based on the state of charge (SOC) of the capacitor 19, the operation state of the motor generator 12 (motor-assisted operation or power generating operation), and the operation state (power running operation or regenerative operation) of the turning motor 21 to thereby control charging/discharging of the capacitor 19. The controller 30 also computes the state of charge (SOC) of the capacitor 19.

FIG. 3 is a circuit diagram illustrating a configuration of the electrical energy storage system 120. The electrical energy storage system 120 includes the capacitor 19 as an electrical energy storage device, the up-down voltage converter 100, and a DC bus 110. The DC bus 110 controls transfer of electric power between the capacitor 19, the motor generator 12, and the turning motor 21. The capacitor 19 includes a capacitor voltage detecting part 112 for detecting a voltage value of the capacitor 19 and a capacitor current detecting part 113 for detecting a current value of the capacitor 19. The capacitor voltage value and the capacitor current value, detected by the capacitor voltage detecting part 112 and the capacitor current detecting part 113, respectively, are supplied to the controller 30.

The up-down voltage converter 100 controls switching between a voltage raising operation and a voltage lowering operation according to the operation states of the motor generator 12 and the turning motor 21 so that the DC bus voltage value falls within a fixed range. The DC bus 110 is arranged between the inverters 18A and 20 and the up-down voltage converter 100, and is configured to transfer electric power to and from the capacitor 19, the motor generator 12, and the turning motor 21.

The switching between the voltage raising operation and the voltage lowering operation of the up-down voltage converter 100 is controlled based on the DC bus voltage value detected by a DC bus voltage detecting part 111, the capacitor voltage value detected by the capacitor voltage detecting part 112, and the capacitor current value detected by the capacitor current detecting part 113.

In the hybrid excavator having the above-described configuration, electric power generated by the motor generator 12 as an assist motor is supplied to the DC bus 110 of the electrical energy storage system 120 via the inverter 18A, and supplied to the capacitor 19 via the up-down voltage converter 100. Regenerative power generated by regenerative operations of the turning motor 21 is supplied to the DC bus 110 of the electrical energy storage system 120 via the inverter 20 and supplied to the capacitor 19 via the up-down voltage converter 100.

The up-down voltage converter 100 includes a reactor 101, a voltage raising IGBT (insulated gate bipolar transistor) 102A, a voltage lowering IGBT 102B, a pair of power supply connection terminals 104 for establishing connection with the capacitor 19, and a pair of output terminals 106 for establishing connection with the inverters 18A and 20. The DC bus 110 is connected between the output terminals 106 of the up-down voltage converter 100 and the inverters 18A and 20, and a smoothing capacitor 107 is connected in parallel to the output terminals 106.

One end of the reactor 101 is connected to the midpoint of the voltage raising IGBT 102A and the voltage lowering IGBT 102B, and the other end of the reactor 101 is connected to one of the power supply connection terminals 104. The reactor 101 is configured to supply to the DC bus 110 an induced electromotive force that is generated by switching on/off the voltage raising IGBT 102A.

Each of the voltage raising IGBT 102A and the voltage lowering IGBT 102B comprises a bipolar transistor having a MOSFET (metal oxide semiconductor field effect transistor) incorporated in its gate portion. Each of the voltage raising IGBT 102A and the voltage lowering IGBT 102B corresponds to a semiconductor element that is capable of switching a large amount of electric power at high speed. Each of the voltage raising IGBT 102A and the voltage lowering IGBT 102B is driven by the controller 30 that supplies a PWM voltage to its gate terminal. A diode 102a and a diode 102b, which correspond to rectifier elements, are connected in parallel to the voltage raising IGBT 102A and the voltage lowering IGBT 102B, respectively.

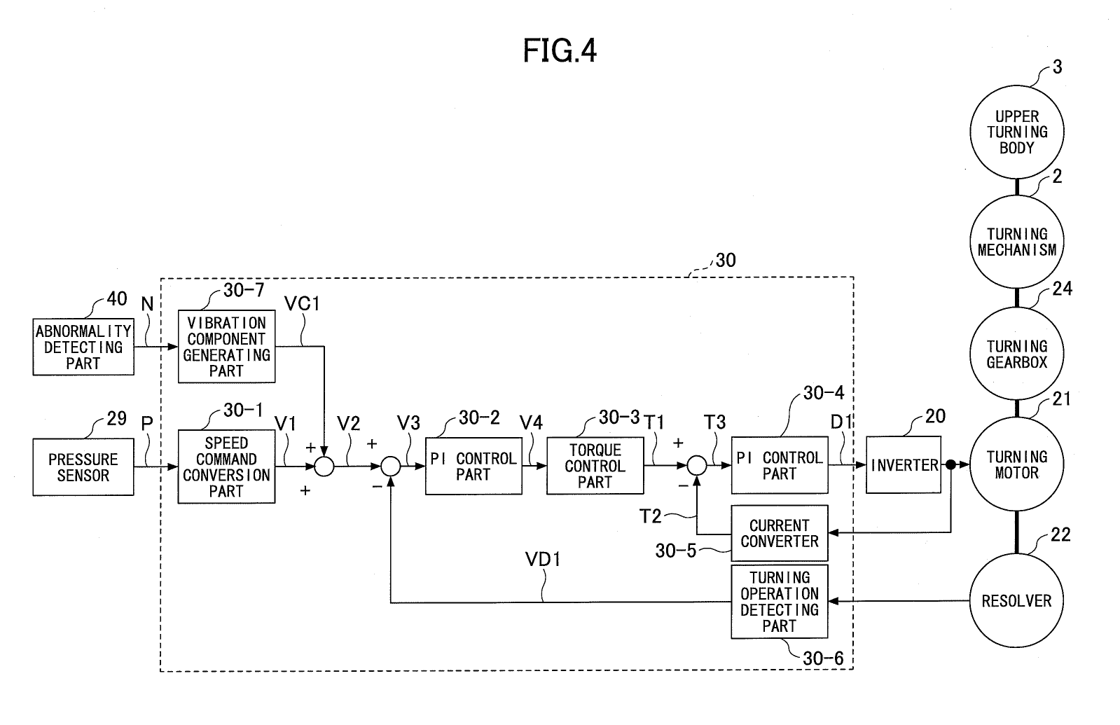

The capacitor 19 may be a chargeable and dischargeable electrical energy storage device that enables transfer of electric power between the capacitor 19 and the DC bus 110 via the up-down voltage converter 100. It is noted that although the capacitor 19 is illustrated in FIG. 4 as an exemplary electrical energy storage device, in other examples, a chargeable and dischargeable secondary battery, such as a lithium ion battery, a lithium ion capacitor, or some other form of power supply that can deliver and receive electric power may be used instead of the capacitor 19.

The power supply connection terminals 104 and the output terminals 106 are terminals capable of establishing connection with the capacitor 19 and the inverter 18A and 20, respectively. The capacitor voltage detecting part 112, which detects the capacitor voltage value, is connected between the power supply connection terminals 104. The DC bus voltage detecting part 111, which detects the DC bus voltage value, is connected between the output terminals 106.

The capacitor voltage detecting part 112 detects the voltage value Vcap of the capacitor 19. The DC bus voltage detecting part 111 detects the voltage value Vdc of the DC bus 110. The smoothing capacitor 107 is an electrical energy storage element that is inserted between the positive-electrode terminal and the negative-electrode terminal of the output terminals 106 and is configured to smooth the DC bus voltage. The voltage of the DC bus 110 is maintained at a predetermined voltage by the smoothing capacitor 107.

The capacitor current detecting part 113 is configured to detect the value of the current flowing at the positive-electrode terminal (P-terminal) side of the capacitor 19. That is, the capacitor current detecting part 113 detects a current value I1 flowing through the positive-electrode terminal of the capacitor 19. On the other hand, a capacitor current detecting part 116 is configured to detect the value of a current flowing at the negative-electrode terminal (N-terminal) side of the capacitor 19. That is, the capacitor current detecting part 116 detects a current value 12 flowing through the negative-electrode terminal of the capacitor 19.

When raising the voltage of the DC bus 110 by the up-down voltage converter 100, a PWM voltage is supplied to the gate terminal of the voltage raising IGBT 102A, and an induced electromotive force generated in the reactor 101 by switching on/off the voltage raising IGBT 102A is supplied to the DC bus 110 through the diode 102b that is connected in parallel to the voltage lowering IGBT 102B. In this way, the voltage of the DC bus 110 is increased.

When lowering the voltage of the DC bus 110 by the up-down voltage converter 100, a PWM voltage is supplied to the gate terminal of the voltage lowering IGBT 102B, and regenerative power supplied via the voltage lowering IGBT 102B and the inverter 20 is supplied from the DC bus 110 to the capacitor 19. In this way, the capacitor 19 is charged with the power stored in the DC bus 110 and the voltage of the DC bus 110 is lowered.

In the present embodiment, a power supply line 114 connects the positive-electrode terminal of the capacitor 19 to the power supply connection terminal 104, and a relay 130-1 that acts as a breaker for interrupting the power supply line 114 is arranged at the power supply line 114. Specifically, the relay 130-1 is arranged between a connection point 115 of the capacitor voltage detecting part 112 to the power supply line 114 and the positive-electrode terminal of the capacitor 19. The relay 130-1 is operated by a signal from the controller 30 and is capable of cutting off the capacitor 19 from the up-down voltage converter 100 by interrupting connection of the power supply line 114 to the capacitor 19.

Also, a power supply line 117 connects the negative-electrode terminal of the capacitor 19 to the power supply connection terminal 104, and a relay 130-2 that acts as a breaker for interrupting the power supply line 117 is arranged at the power supply line 117. Specifically, the relay 130-2 is arranged between a connection point 118 of the capacitor voltage detecting part 112 to the power supply line 117 and the negative-electrode terminal of the capacitor 19. The relay 130-2 is operated by a signal from the controller 30 and is capable of cutting off the capacitor 19 from the up-down voltage converter 100 by interrupting connection of the power supply line 117 to the capacitor 19. It is noted that in an alternative embodiment, the relays 130-1 and 130-2 may be a single relay that simultaneously interrupts both the positive-electrode terminal side power supply line 114 and the negative-electrode terminal side power supply line 117 to cut off the capacitor 19 from the up-down voltage converter 100.

Also, it is noted that in practical applications, a drive part that generates a PWM signal for driving the voltage raising IGBT 102A and the voltage lowering IGBT 102B is arranged between the controller 30 and each of the voltage raising IGBT 102A and the voltage lowering IGBT 102B. However, the illustration of the drive part is omitted in FIG. 3. Such a drive part may be constructed by either an electronic circuit or a processor unit.

In the present embodiment, the upper turning body 3 is turned by the above-described electric turning device. The electric turning device includes the turning mechanism 2 for turning the upper turning body 3, the turning motor 21 as an electric motor for driving the turning mechanism 2, the inverter 20 for supplying electric power to the turning motor 21, and the controller 30 as a control unit for controlling drive operations of the inverter 20.

The electric turning device of the present embodiment also includes an abnormality detecting part 40 (see FIG. 4) that detects an abnormality such as a failure of the operation of the excavator, for example. The abonormality detecting part 40 includes the capacitor voltage detecting part 112, the capacitor current detecting parts 113 and 116, a temperature detector 140, and the resolver 22. Abnormalities that may be detected by the abnormality detecting part 40 include abnormalities or failures relating to the operational functions or operation state of the excavator and abnormalities in the surrounding environment of the excavator. That is, the abnormalities detected by the abnormality detecting part 40 may include any type of abnormality or failure of which the operator should be notified. More specifically, the capacitor current detecting parts 113 and 116 may detect breaking abnormalities. The temperature detector 140 may be arranged at the turning motor 21 to detect overloading abnormalites of the turning motor 21, for example.

According to an aspect of the present embodiment, an electric tuning device including an electric motor that has good responsiveness is used so that electric power supplied to the electric motor may be more precisely controlled and a desired vibration may be generated more easily compared to the case of using a hydraulic turning drive device. That is, by using the electric turning device, operations of the tuning device may be more precisely controlled.

When the abnormality detecting part 40 detects an abnormality, the electric turning device according to the present embodiment generates a drive signal to be supplied to the turning motor 21 to prompt the turning motor 21 to generate a vibration in its turning direction so that an operator may be notified of the occurrence of the abnormality. Specifically, when the abnormality detecting part 40 detects an abnormality, the controller 30 acting as the control unit of the electric turning device adds a vibration component to a drive command to be supplied to the turning motor 21, and supplies the drive command including the vibration component to the inverter 20.

The inverter 20 supplies a drive current based on the drive command including the vibration component. In this way, a vibration is generated in the power generated by the turning motor 21, and a vibration that can be felt by the operator is generated at the upper turning body 3 that is being turned. The vibration is preferably arranged to be adequately small so that turning operations of the upper turning body 3 may not be impaired.

The operator maneuvering the excavator inside the cabin 10 of the upper turning body 3 may feel the vibration through his body and become aware of the occurrence of some type of abnormality or failure.

That is, in the present embodiment, a notification or a warning of the occurrence of an abnormality may be communicated to the operator by generating a vibration in the turning operation of the upper turning body. It is noted that information to be communicated to the operator through such a vibration is not limited to abnormalities or failures occurring at the excavator or its surrounding but may include any type of information suitable for notification to the operator such as the operation state of the excavator.

For example, information to be communicated to the operator may include an abnormality occurring in the surrounding environment of the excavator that may be detected by a camera 150. When a person enters a work area of the excavator (turning range of the boom 4, the arm 5, and the bucket 6 attached to the upper turning body 3), it may be dangerous to operate the excavator. Thus, this may be detected by the camera 150 as an abnormality in the surrounding environment, and a vibration may be generated at the upper turning body 3 so that the operator may be notified or warned of the abnormality.

The operator inside the cabin 10 of the upper turning body 3 will often be watching the bucket 6 so that only the direction of the bucket 6 may be in his view. Thus, when a person enters the turning range of the excavator that is outside the operator's range of view, the operator may not be able to notice such an abnormality in the surrounding environment. In the electric turning device of the present embodiment, the abnormality detecting part may detect when a person enters the work area of the excavator, and in turn, a vibration may be generated at the upper turning body 3 so that the operator may be notified or warned of the abnormality.

During operation of the excavator, noise from driving and operating the excavator may be quite loud so that even when a warning sound is issued, the operator may not be able to hear the warning sound. Also, a warning using an indicator may not be effective unless the operator is looking at the indicator unit or indicator light. However, by communicating the warning through vibration of the upper turning body 3, the operator may effectively be notified of the warning because the operator in the cabin 10 of the upper turning body 3 may always be able to feel the vibration of the upper turning body 3.

Also, the electric turning device of the present embodiment may be able to notify the person entering the work area of the dangers of being in that particular area. That is, when a vibration that is not normally observed occurs at the upper turning body 3 of the excavator, the person entering the work area may also recognize the abnormal vibration through his visual or auditory senses and understand that he is in an abnormal and dangerous environment. In turn, the person that has entered the work area may look around to see that he is in the work area of the excavator, for example.

The abnormality detecting part 40 for detecting an abnormality of the surrounding environment of the excavator may be a video camera arranged at the excavator, for example. During operation of the excavator, the video camera may capture images of areas surrounding the upper turning body 3, and the abnormality detecting part 40 may detect an abnormality by detecting an image of a person entering the work area or an obstacle placed within the work area, for example.

The abnormality detecting part 40 for detecting an abnormality or failure of the excavator itself may be some type of detector. For example, a temperature sensor that detects the temperature of cooling water for cooling the engine 11 may be used as the abnormality detecting part 40. In this case, overheating of the engine 11 may be detected as an abnormality and the operator may be notified of the abnormality through vibration of the upper turning body 3. Although not specifically illustrated, other various abnormalities and failures may be detected by the abnormality detecting part 40, and various known means for detecting such abnormalities may be used as the abnormality detecting part 40.

Also, in the case of issuing a warning through vibration, different types of vibrations may be generated depending on the urgency level of the warning (e.g., depending on whether the warning is serious or relatively minor). For example, a slight vibration that is simply felt and noticed by the operator may signal a minor warning whereas a greater vibration that may bring about some discomfort to the operator may signal a serious warning.

The slight vibration for signaling a minor warning may be a vibration that causes the turning motor 21 to vibrate but barely causes vibration of the upper turning body 3 itself, for example. To generate such a slight vibration, a vibration at a relatively high frequency (e.g., from 10 Hz to several tens of hertz (Hz)) or relatively small amplitude may be used, for example.

On the other hand, the vibration for signaling a serious warning may be a vibration that is clearly felt by the operator. The vibration may bring about a sense of discomfort or a sense of abnormality to the operator, for example. Such a vibration may be a sufficiently strong vibration that causes vibration of the upper turning body 3 itself, or a vibration at a frequency that is close to the natural frequency of the upper turning body 3 (corresponding to a machine parameter) that induces resonance of the upper turning body 3, for example. The frequency of such a vibration may be within a relatively low frequency range from around several hertz (Hz) to 10 Hz, for example. Also, the amplitude of the vibration may be arranged to be greater than the amplitude of the slight vibration described above so that the two types of vibrations may be distinguished over the other.

As can be appreciated from above, different types of vibrations may be generated by changing the amplitude and frequency of the vibration according to the machine parameter. By changing the combination of the amplitude and the frequency of vibrations, different types of vibrations may be generated.

Also, as another method of generating different types of vibrations, the vibration waveform may be changed. For example, the vibration component added to the drive command to be supplied from the controller 30 to the inverter 20 may be arranged to have different waveforms such as a rectangular wave, a sine wave, or a triangular wave so that the vibration mode of the output of the turning motor 21 generated based on the drive command may be varied. In this way, different modes of vibrations may be generated at the upper turning body 3, and the operator sensing a vibration of the upper turning body 3 may determine the information conveyed by the vibration by distinguishing the corresponding mode of the vibration. It is noted that the different vibration waveforms are not limited to a rectangular wave, a sine wave, and a triangular wave, but may also be combinations thereof, for example.

In the following, control functions for adding a vibration component to a drive command in the electric turning device of the present embodiment are described. The drive command to which a vibration component is added may include a speed command and a torque command directed to a current value for controlling the current to be supplied to the turning motor 21, for example.

FIG. 4 is a block diagram illustrating an exemplary functional configuration for generating a drive command by adding a vibration component to a speed command.

When an operator operates a turning operation lever to turn the upper turning body 3, an operation amount (lever input amount) of the turning operation lever is detected by the pressure sensor 29, and an output P of the pressure sensor 29 is input to a speed command conversion part 30-1 of the controller 30. The speed command conversion part 30-1 generates a speed command V1 indicating the rotational speed of the turning motor 21 based on the output P of the pressure sensor 29 and outputs the generated speed command V1.

When the abnormality detecting part 40 detects an abnormality, it determines whether the abnormality should be reported to the operator. If it is determined that the abnormality should be reported to the operator, the abnormality detecting part 40 outputs a notification signal N indicating whether a notification or a warning needs to be issued. The notification signal N may include a type signal indicating the type of vibration that should be generated. The notification signal N is input to a vibration component generating part 30-7 of the controller 30. The vibration component generating part 30-7 generates a speed vibration component VC1 based on the notification signal N and outputs the generated speed vibration component VC1.

The speed vibration component VC1 output from the vibration component generating part 30-7 is added to the speed command V1 output from the speed command conversion part 30-1, and as a result, a speed command V2 is generated. Then, a speed detection signal VD1 indicating the current speed of the turning motor 21 is subtracted from the speed command V2, and as a result, a speed command V3 is generated. The speed detection signal VD1 is a signal indicating the current speed of the turning motor 21 that is generated by a turning operation detecting part 30-6 based on an output signal from the resolver 22. The speed command V3 is input to a proportional integration (PI) control part 30-2 where a proportional integration control process is applied on the speed command V3 to generate a speed command V4, which is input to a torque control part 30-3. The torque control part 30-3 adds a torque limit to the speed command V4 to generate a torque current command T1.

Then, a torque current value T2 generated by a current conversion part 30-5 is subtracted from the torque current command T1 output from the torque control part 30-3, and as a result, a torque current command T3 is generated and input to a proportional integration (PI) control part 30-4. The PI control part 30-4 applies a proportional integration control process on the torque current command T3 to generate a drive command Dl and outputs the generated drive command D1 to the inverter 20.

The inverter 20 supplies a drive current to the turning motor 21 based on the drive command Dl. This drive current includes the vibration component generated by the vibration component generating part 30-7, and the turning motor 21 is vibrated by the vibration component upon being driven by the drive current. In turn, a vibration is generated at the upper turning body 3 that is driven by the turning motor 21, and this vibration may be felt by the operator.

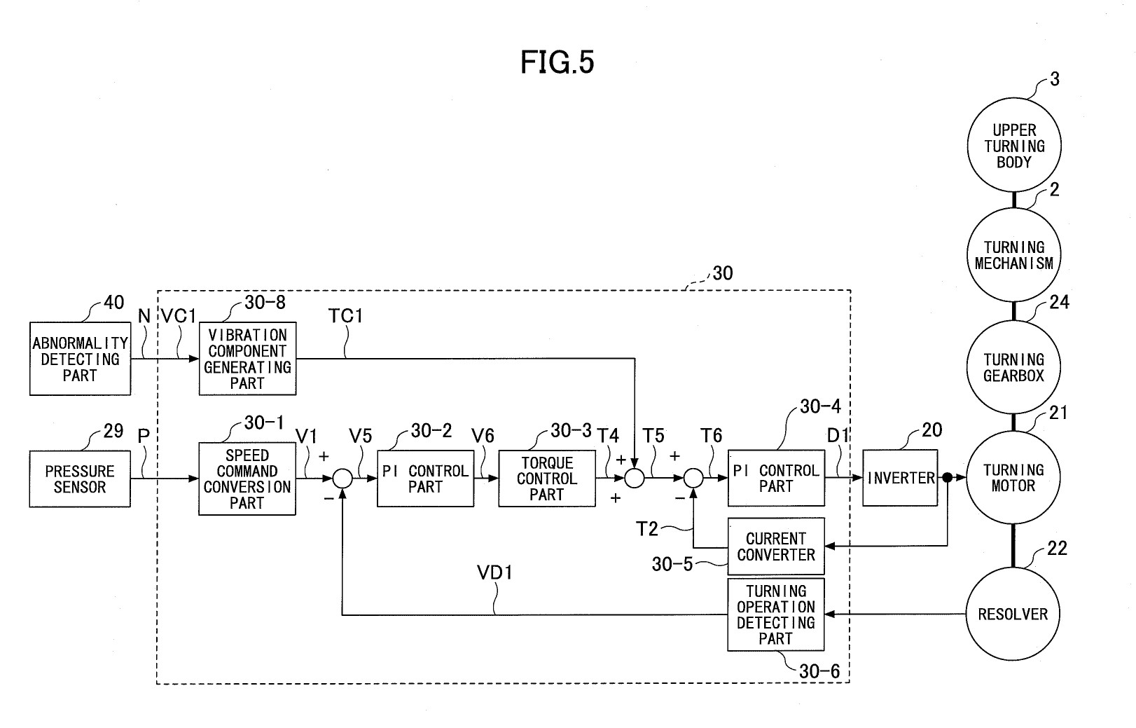

FIG. 5 is a block diagram illustrating an exemplary functional configuration for generating a drive command by adding a vibration component to a torque command.

When the operator operates the turning operation lever to turn the upper turning body 3, the operation amount (lever input amount) of the turning operation lever is detected by the pressure sensor 29, and the output P of the pressure sensor 29 is input to the speed command conversion part 30-1 of the controller 30. The speed command conversion part 30-1 generates the speed command V1 indicating the rotational speed of the turning motor 21 based on the output P of the pressure sensor 29 and outputs the generated speed command Vl.

Then, the speed detection signal VD1 generated by the turning operation detecting part 30-6 is subtracted from the speed signal V1, and as a result, a speed command V5 is generated. The speed command V5 is input to the PI control part 30-2, and a proportional integration control process is applied to the speed command 5 to generate a speed command V6, which is output to the torque control part 30-3. The torque control part 30-3 adds a torque limit to the speed command V6 to generate a torque current command T4.

When the abnormality detecting part 40 detects an abnormality, it determines whether the abnormality should be reported to the operator. If it is determined that the abnormality should be reported to the operator, the abnormality detecting part 40 outputs the notification signal N indicating whether a notification or a warning needs to be issued. The notification signal N may include a type signal indicating the type of vibration that should be generated. The notification signal N is input to a vibration component generating part 30-8 of the controller 30. The vibration component generating part 30-8 generates a torque vibration component TC1 based on the notification signal N and outputs the generated torque vibration component TC1.

The torque vibration component VC1 output from the vibration component generating part 30-8 is added to the torque current command T4, and as a result, a torque current command T5 is generated. Then, the torque current value T2 generated by the current conversion part 30-5 is subtracted from the torque current command T5, and as a result, a torque current command T6 is generated. The generated torque current command T6 is input to the PI control part 30-4. The PI control part 30-4 applies a proportional integration control process on the torque current command T6 to generate the drive command D1, and outputs the generated drive command D1 to the inverter 20.

The inverter 20 supplies a drive current to the turning motor 21 based on the drive command D1. This drive current includes the vibration component generated by the vibration component generating part 30-8, and the turning motor 21 is vibrated by the vibration component upon being driven by the drive current. In turn, a vibration is generated at the upper turning body 3 that is driven by the turning motor 21, and this vibration may be felt by the operator.

It is noted that although the speed command conversion part 30-1, the PI control parts 30-2 and 30-4, the torque control part 30-3, the current conversion part 30-5, the turning operation detecting part 30-6, and the vibration component generating parts 30-7 and 30-8 are included in the controller 30 in the above-described embodiment, a separate control unit embodying these functional elements may be provided. Such a control unit may have a configuration similar to that of the controller 30 and include a CPU, a ROM, and a RAM for executing the functions of the speed command conversion part 30-1, the PI control parts 30-2 and 30-4, the torque control part 30-3, the current conversion part 30-5, the turning operation detecting part 30-6, and the vibration component generating parts 30-7 and 30-8.

As described above, the electric turning device according to an embodiment of the present invention is configured to control drive operations of the turning motor 21 to generate a vibration at the upper turning body 3. That is, in the present embodiment, vibration occurs at the upper turning body 3 rather than the operation lever operated by the operator. Because the operator would not feel any vibration of the operation lever, the risk of erroneous operations of the operation lever by the operator or interruption of the lever operation caused by the operator inadvertently letting go of the operation lever may be reduced and operation safety may be improved, for example. Also, because no special component needs to be added to generate a vibration according to the present embodiment, configurations for issuing a notification or a warning may be inexpensively arranged.

Further, it is noted that because the attachment weight and the inertia of work elements such as the boom and the arm of the excavator are relatively large, even when the upper turning body 3 is vibrated, the vibration may be damped by the attachment such that the tip end portion of the attachment (i.e., bucket portion) would hardly be affected (vibrated). Thus, even when the upper turning body 3 is vibrated, an object mounted on the bucket may not be affected by the vibration. That is, the occurrence of an abnormality may be effectively communicated to the operations in the cabin without affecting the object mounted on the bucket.

While certain preferred embodiments of the present invention have been described above, the present invention is not limited to these embodiments, and various changes and modifications may be made without departing from the scope of the present invention.

What is claimed is:

1. An electric turning device comprising:
an electric motor configured to drive and turn an upper turning body that is rotatably arranged on a base part;
an inverter that supplies electric power to the electric motor;
a control part that supplies a drive command for controlling drive operations of the electric motor to the electric motor according to a lever input amount; and
an abnormality detecting part that detects an abnormality;
wherein when the abnormality detecting part detects the abnormality, the control part arranges the drive command to include a vibration component and supplies the drive command including the vibration component to the electric motor.

2. The electric turning device as claimed in claim 1, wherein
the control part generates the drive signal by adding the vibration component to an operation command that is generated according to the lever input amount.

3. The electric turning device as claimed in claim 1, wherein
at least one of an amplitude and a frequency of the vibration component is changed according to at least one of a type of the abnormality and a machine parameter.

4. The electric turning device as claimed in claim 1, wherein
a vibration waveform of the vibration component includes at least one of a rectangular wave, a sine wave, and a triangular wave.
